(19) United States
(12) Patent Application Publication
(10) Pub. No.: US 2025/0283507 A1
(43) Pub. Date: Sep. 11, 2025

(54) BEARING UNIT WITH RETENTION CAGE

(71) Applicant: AKTIEBOLAGET SKF, GOTEBORG (SE)

(72) Inventors: Federico DAL ZILIO, None (IT); Alexander MOCNIK, Steyr (AT); Carl Patric Daniel NORIN JANSSON, Göteborg (SE); Alessio NEBBIA COLOMBA, Pisa (IT)

(21) Appl. No.: 19/062,191

(22) Filed: Feb. 25, 2025

(30) Foreign Application Priority Data
Mar. 8, 2024 (IT) 102024000005248

(51) Int. Cl. F16C 33/38; B33Y 80/00

(52) U.S. Cl. CPC F16C 33/3856; B33Y 80/00

(57) ABSTRACT

A bearing unit has a central rotation axis, a radially outer ring, a radially inner ring, and a retention cage configured to retain a row of rolling bodies between the inner ring and the outer ring. The retention cage is centered on the radially external ring and includes a one-piece annular body having a plurality of through pockets each configured to house and retain one of the rolling bodies. A first ring of material is located on a first axial side of the through pockets, a second ring of material is located on a second axial side of the through pockets, a bridge extends from the first ring of material to the second ring of material between each adjacent pair of the through pockets, and a lightening through opening is located at a first end of each bridge and at a second end of each bridge.

### CROSS-REFERENCE

This application claims priority to Italian patent application no. 102024000005248 filed on Mar. 8, 2024, the contents of which are fully incorporated herein by reference.

### TECHNOLOGICAL FIELD

The present disclosure relates to a bearing unit with a retention cage. In particular, the bearing unit is an angular-contact bearing unit for applications requiring high precision, for example machine tools.

### BACKGROUND

Known bearing units with a retention cage include a radially outer ring, a radially inner ring, a plurality of rolling bodies, in particular balls, interposed between the inner ring and the outer ring to enable the relative rotation thereof, and a retention cage that holds the balls in respective circumferential positions.

The retention cage of a known type comprises a one-piece annular body that defines a reference axis, the body of the cage delimiting substantially cylindrical cavities or pockets distributed about the reference axis. The balls are housed in these cavities, which define the positioning and holding of the balls.

These retention cages are usually used in high-velocity, high-vibration bearing units, in particular for applications in the industrial sector, for example in machine tool spindles, and are typically made by injection molding a polymer material, including to compensate for poor lubrication conditions. As the bearing unit requires a high degree of precision, the cages for these applications must also meet this accuracy requirement. Therefore, the cages are finished with machine tools and must therefore have a very simple geometry.

One drawback of this type of retention cage is the excessive state of internal stress, which is moreover localized and unevenly distributed. This drawback affects the use of the cages in cutting-edge applications with very high rotational speeds.

### SUMMARY

One objective of the present invention is to provide a bearing unit with a retention cage that does not have the drawback described above.

One aspect of the disclosure comprises a bearing unit having a central rotation axis of rotation. The bearing unit includes a radially outer ring, a radially inner ring, and a retention cage configured to retain a row of rolling bodies between the inner ring and the outer ring. The retention cage is centered on the radially external ring and comprises a one-piece annular body having a plurality of through pockets each configured to house and retain one of the rolling bodies. A first ring of material is located on a first axial side of the through pockets, and a second ring of material is located on a second axial side of the through pockets. A bridge extends from the first ring of material to the second ring of material between each adjacent pair of the through pockets. A lightening through opening is located at a first end of each bridge and at a second end of each bridge.

### BRIEF DESCRIPTION OF THE DRAWINGS

The invention is described below with reference to the attached drawings, which show non-limiting example embodiments thereof, in which:

FIG. 1 is an axonometric view of a bearing unit according to a first embodiment of the present disclosure.

FIG. 2 is an axonometric view of the retention cage of the bearing unit of FIG. 1.

FIG. 3 is a detail of the retention cage of FIG. 2.

### DETAILED DESCRIPTION

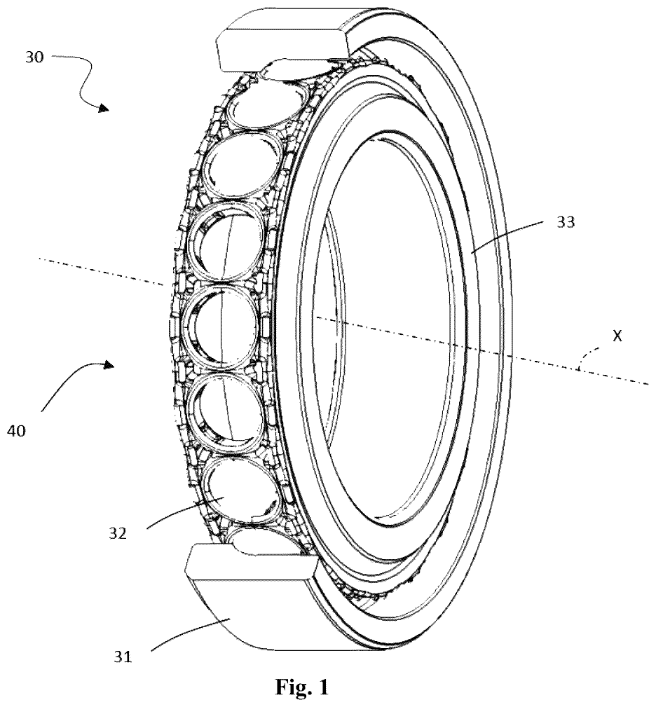

In FIG. 1, reference sign 30 denotes a bearing unit as a whole, according to a preferred embodiment of the present invention. The bearing unit 30 has a central rotation axis X and comprises a stationary radially outer ring 31, a rotary radially inner ring 33, a row of rolling bodies 32, in particular balls, interposed between the radially outer ring 31 and the radially inner ring 33, and a cage 40 for holding the rolling bodies 32 in place, the cage being centered on the radially outer ring 31.

Throughout the present description and in the claims, terms and expressions indicating positions and orientations, such as “radial” and “axial”, are to be understood with reference to the central rotation axis X of the bearing unit 30, unless otherwise specified. For the sake of simplicity, the term “ball” may be used by way of example in the present description and in the attached drawings instead of the more generic term “rolling body,” and the same reference signs shall be used.

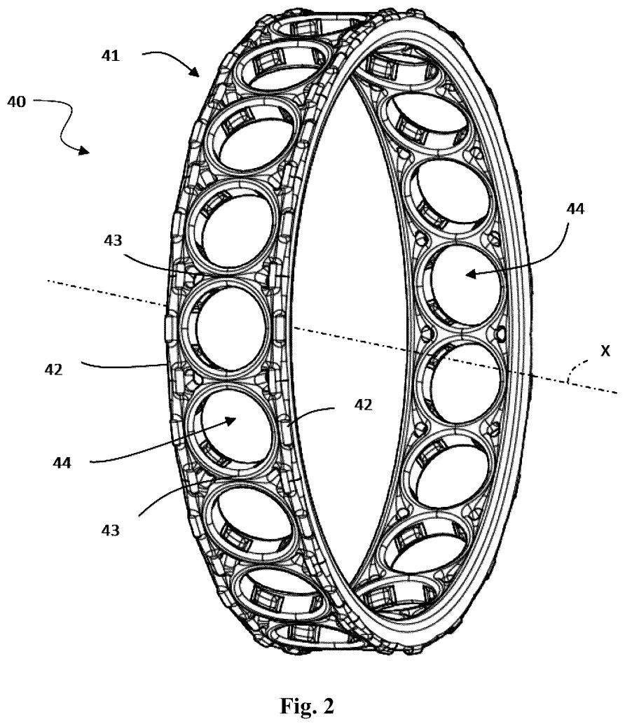

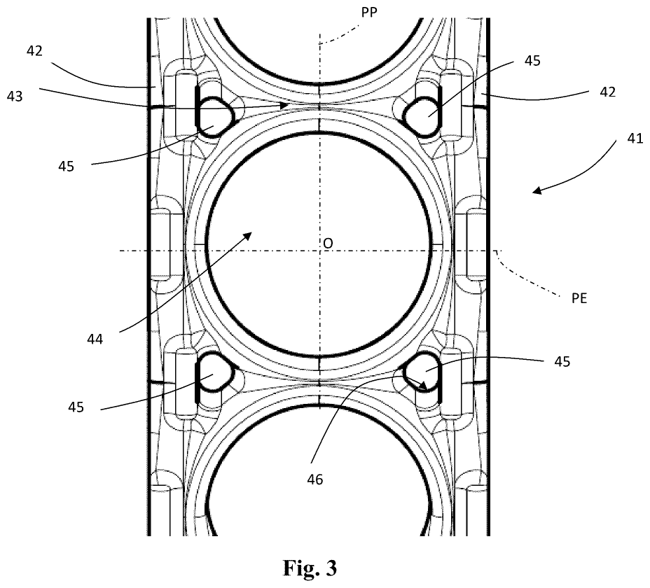

With reference to FIGS. 2 and 3, the cage 40 has an annular shape defining a main axis of inertia or reference axis, which is coincident with the central rotation axis X of the bearing unit 30.

The retention cage 40 has a one-piece annular body 41 that forms two rings 42 connected by bridges 43. The annular body 41 of the cage 40 can be made of any suitable material, in particular any material suitable for additive manufacturing, for example plastic, ceramic or metal material. An example of a material preferably used is a composite material based on cotton fibers impregnated with a phenolic resin.

The two rings 42 and the bridges 43 delimit a plurality of through-cavities 44 separated by pairs of the bridges 43 and each framed by the two rings 42. A radially outer surface 45 of the cavity 44 delimits the boundary of the cavity with respect to the two rings 42 and the pair of bridges 43. The through-cavities 44 house respective rolling bodies 32, in particular balls, in order to position and retain the rolling bodies.

Each through-cavity 44 has a polar plane PP and an equatorial plane PE, both perpendicular to the annular body 41. Each through-cavity 44 has a center O at the intersection of these two planes. The centers O of the cavities are all located at an equal distance from the central rotation axis X.

An aspect of the present disclosure is to optimize the topology of the cage 40, in particular a cage for a super-precision angular-contact bearing unit able to operate optimally at high speed (with a NDm speed factor of approximately 3 million). Optimization is focused on distributing internal stresses better than in known solutions.

To this end, the annular body 41 of the cage 40 has a plurality of lightening second through-cavities 45 arranged substantially at the intersections of each ring 42 with the respective bridge 43. Each first through-cavity 44 is therefore surrounded by four second through-cavities 45, spaced apart angularly by 90° about the center O of the first through-cavity 44. In addition, the four second through-cavities 45 surrounding a first through-cavity 44 are symmetrical in pairs about the equatorial plane PE and the polar plane PP of the respective cavity.

Over the entire circumference of the annular body 41, there are exactly twice as many second through-cavities 45 as first through-cavities 44. For example, a typical cage for use in an angular-contact bearing unit is provided with 19 first through-cavities 44, and therefore has 38 lightening second through-cavities 45. Preferably, the second through-cavities 45 are not circular, but three-lobed, with the three lobes 46 arranged angularly at 120°.

The diameter of the second through-cavity 45 (more precisely, the equivalent diameter, that is, the diameter of a circular opening having the same area as the second through-cavity 45) is advantageously between ⅙ and ⅕ of the diameter of the first through-cavity 44. Reference values for the diameter of the lightening second through-cavities 45 for a typical application are between 1.2 mm and 1.6 mm. Clearly, smaller values do not structurally compromise the strength of the cage, but reduce the mass of the component to a lesser extent and provide a smaller passage for the lubricating grease. Conversely, larger values can cause a reduction in the structural capacity of the cage, greatly increasing the risk of breakage.

This geometry—the number, shape and diameter of the second through-cavities—is the result of optimizing the design of the cage to lighten it as much as possible without reducing the strength thereof, thereby optimizing stress distribution.

In fact, the second through-cavities 45 are placed in the section where the cage would otherwise have the highest concentration of material. The lightening second through-cavities 45 reduce the material used to make the cage and therefore provide the benefit of reducing the weight of the cage or, for the same weight, reducing the maximum stress. At the same time, a second benefit is to facilitate the flow of lubricant towards the outer region of the cage, taking advantage of the conventional pumping effect of an angular-contact bearing unit. In fact, centrifugal effects can cause the lubricating grease to flow through the first through-cavities 44 and the second through-cavities 45 from the radially inner portion of the cage to the radially outer portion, where the cage 40 is mounted on the radially outer ring 31.

The disclosure therefore provides a topologically optimized design that optimizes the distribution of the internal stresses generated by external sources, such as centrifugal forces and/or impacts. In particular, for the same weight, the maximum resultant stress is reduced by 33% in the new design compared to the known design.

Topology optimization is a process that combines design tools and FEM calculations to create custom shapes of common objects that better distribute loads and reduce the overall stress acting on the component. The principle of topology optimization has been applied to a cage for super-precision angular-contact ball bearings, assuming that the component is made using additive manufacturing techniques, which enables the potentially complex geometries resulting from the optimized topology design to be realized, among other things.

Thus, although the above disclosure is applicable to any method of manufacturing the bearing unit cage, given the particular geometry of the cage, as described above, the disclosure is particularly suitable for a cage of a bearing unit in which the body is obtained by additive manufacturing.

Ultimately, the disclosure provides multiple advantages. A first advantage is that he entire cage can be obtained using a known injection molding process or, preferably, using other processes such as additive manufacturing. Another advantage is that topology optimization reduces the maximum stress on the weakest section by 33%, for the same cage weight. In addition, optimization also facilitates the recirculation of the lubricant through the lightening second through-cavities.

Numerous other variants exist in addition to the embodiments described above. The embodiments are provided solely by way of example and do not limit the scope of the invention, its applications or its possible configurations. Indeed, although the description provided above enables the person skilled in the art to carry out the present invention at least according to one example configuration thereof, numerous variations of the components described could be used without thereby departing from the scope of the invention, as defined in the attached claims interpreted literally and/or according to their legal equivalents.

What is claimed is:

1. A bearing unit having a central rotation axis and comprising:
a radially outer ring,
a radially inner ring,
a retention cage configured to retain a row of rolling bodies between the inner ring and the outer ring, the retention cage being centered on the radially external ring and comprising:
a one-piece annular body having a plurality of through pockets each configured to house and retain one of the rolling bodies,
a first ring of material located on a first axial side of the through pockets, and
a second ring of material located on a second axial side of the through pockets
a bridge extends from the first ring of material to the second ring of material between each adjacent pair of the through pockets, and
a lightening through opening located at a first end of each bridge and at a second end of each bridge.

2. The bearing unit according to claim 1,
wherein each through pocket is surrounded by four of the lightening through openings angularly spaced by 90° with respect to a center of the through pocket.

3. The bearing unit according to claim 1,
wherein each of the through pockets is conceptually divided into four quadrants by an equatorial plane perpendicular to a circumferential direction and including the central rotational axis and a polar plane perpendicular to the equatorial plane,
wherein four of the lightening through openings surround each of the through pockets, and
wherein each of the four lightening through openings is located in one of the four quadrants.

4. The bearing unit according to claim 3,
wherein each of the four lightening through openings is located on a vertex of an imaginary rectangle.

5. The bearing unit according to claim 1,
wherein a number of the lightening through openings is exactly twice a number of the through pockets.

6. The bearing unit according to claim 1,
wherein the lightening through openings each have three lobes angularly spaced by 120°.

7. The bearing unit according to claim 6,
wherein a ratio between an equivalent diameter of the lightening through opening and a diameter of one of the through pockets is between 1:6 and 1:5.

8. The bearing unit according to claim 1,
wherein a ratio between an equivalent diameter of the lightening through opening and a diameter of one of the through pockets is between 1:6 and 1:5.

9. The bearing unit according to claim 1,
wherein the annular body of the cage is formed by an additive manufacturing process.

10. The bearing unit according to claim 8,
wherein the annular body is formed from cotton fibers impregnated with a phenolic resin.

11. The bearing unit according to claim 1,
wherein the annular body is formed from cotton fibers impregnated with a phenolic resin.
